(19) United States
(12) Patent Application Publication
(10) Pub. No.: US 2016/0012741 A1
(43) Pub. Date: Jan. 14, 2016

(54) EDUTAINMENT SYSTEM FOR SUPPORTING LINKAGE OF ELECTRONIC BOOK AND GAME

(71) Applicant: WEDU COMMUNICATIONS CO., LTD., Mapo-gu Seoul (KR)

(72) Inventor: Kyu Ha Lee, Goyang (KR)

(21) Appl. No.: 14/770,537

(22) PCT Filed: Feb. 27, 2014
(86) PCT No.: PCT/KR2014/001613

§ 371 Date: Aug. 26, 2015

(30) Foreign Application Priority Data
Feb. 27, 2013 (KR) 10-2013-0020972
Apr. 10, 2013 (KR) 10-2013-0039089

(51) Int. Cl. G09B 7/00; G06F 3/0483; A63F 13/47; A63F 13/67; A63F 9/24; A63F 13/798

(52) U.S. Cl. CPC G09B 7/00; A63F 9/24; A63F 13/798; A63F 13/47; A63F 13/67; G06F 3/0483; A63F 2009/245

(57) ABSTRACT

An edutainment system is disclosed. The edutainment system according to the present invention comprises: an electronic book processing unit for playing an electronic book and analyzing the reading of a user; and a game processing unit for executing a game and analyzing the game playing of the user. As such, the result of the analysis of the user's reading is provided to the game processing unit, so that the result is reflected in the game when the user plays same after reading so as to allow a learning concept the user acquired in the reading process to be tacitly repeated by the user through the game play. Conversely, the result of the analysis of the user's game playing is provided to the electronic book processing unit and utilized for determining the branching direction of the content of the electronic book when the user reads same after the game play.

### TECHNICAL FIELD

The present invention disclosed herein relates to an edutainment technology field.

### BACKGROUND ART

Edutainment, which is a compound word of education and entertainment, refers to an educational form that enables interesting learning as if a learner enjoys games.

Compared to classic type of learning processes, edutainment arouses learner's interest, and allows a learner to be immersed in learning through strong amusement.

Edutainment or edutainment content generally is utilized to strengthen the learning motive of children of low age and lead them to voluntary learning activity.

Thus, children are not forced to learn, and can pleasantly learn while acquainting various concepts through play.

However, in typical edutainment, since learning elements are merely delivered by implication during play, learning theme cannot be directly and clearly delivered.

Also, since a long-term memorizing process cannot be provided, learning content is easily forgotten when playing game is finished.

Meanwhile, for the improvement of learning performance, optimized and customized contents need to be provided in accordance with the learning level or comprehension of children. However, since learning is not explicitly performed like E-learning, tracking is not easy.

If learning is explicitly performed like E-learning, a series of processes such as basic learning, improvement of comprehension through exercises, and assessment through problem solution are sequentially performed, and tracking can be easily performed only by collecting learning results of learners on each process. Also, through the tracking results, learning contents or learning methodologies customized for learners can be provided.

However, in edutainment, since learning themes are explicitly delivered and explicit assessment such as problem solution is not performed, it is not easy to track learning processes or results unlike typical E-learning.

### DISCLOSURE

### Technical Problem

The present invention provides a methodology of learning knowledge by understanding and repetition of concepts through a play process without an explicit learning process, by equally dividing a space in which an edutainment service is provided into an electronic type of books and games.

The present invention also provides a methodology of indirectly acquiring and tracking indicators about learning activities by interworking an electronic book with a game and analyzing a reading behavior of a user through electronic book and a game play behavior of a user.

The present invention also provides a methodology of reflecting a game play result in the content of an electronic book using a tracking result from the user behavior analysis and reflecting the reading behavior analysis result of the electronic book in selecting contents provided in a game.

The present invention also provides a methodology of increasing the degree of understanding on learning contents and efficiently operating a conversion mechanism into long-term memory, by repetitively arousing learned knowledge provided to a user through reading of an electronic book, using a game.

### Technical Solution

In one general aspect, an edutainment system for supporting interworking of an electronic book and a game, the system including a terminal device playing the electronic book or the game to display on a display device in accordance with a user input through a user interface device, the edutainment system includes: an electronic book processing part including an electronic book play unit sequentially playing unit book contents of the electronic book including a plurality of unit book contents, and a reading tracking unit analyzing a reading behavior of a user; and a game processing unit including a game executing unit executing the game including a plurality of game contents, and a game tracking unit analyzing a game play behavior of a user, wherein: at least one of the unit book contents included in the electronic book branches into two or more unit book contents; while the electronic book is being played by the electronic book play unit, the reading tracking unit tracks a user input through a user interface device to analyze the reading behavior of a user, and then provides the analysis result for the game processing part; the game executing unit executes the game in accordance with manipulation of a user, and when the analysis result on the reading behavior of a user is received from the reading tracking unit, the game executing unit selects game contents to be executed in the game, using the analysis result of the reading behavior and then executes the game contents that are selected; the game tracking unit analyzes the game play behavior of a user, and then provides the analysis result for the electronic book processing part; and the electronic book play unit plays the unit book contents included in the electronic book in a certain order when the electronic book is played, and when the analysis result of the game play behavior of a user is received from the game tracking unit, selects unit book contents to be branched using the received analysis result of the game play behavior after the play of the unit book contents which branch into two or more unit book contents and further plays the selected unit book contents.

In another general aspect, an edutainment system for supporting interworking of an electronic book and a game, the system including a terminal device playing the electronic book or the game to display on a display device in accordance with a user input through a user interface device, the edutainment system includes: an electronic book processing part including an electronic book play unit sequentially playing unit book contents of the electronic book including a plurality of unit book contents, and a reading tracking unit analyzing a reading behavior of a user; and a game processing unit including a game executing unit executing the game including a plurality of game contents, and a game tracking unit analyzing a game play behavior of a user, wherein: at least one of the unit book contents included in the electronic book branches into two or more unit book contents; the game tracking unit analyzes the game play behavior of a user, and then provides the analysis result for the electronic book play unit; and the electronic book play unit plays the unit book contents included in the electronic book in a certain order when the electronic book is played, and when the analysis result of the game play behavior of a user is received from the game tracking unit, selects unit book contents to be branched using the received analysis result of the game play behavior after the play of the unit book contents which branch into two or more unit book contents and further plays the selected unit book contents.

In another general aspect, an edutainment system for supporting interworking of an electronic book and a game, the system including a terminal device playing the electronic book or the game to display on a display device in accordance with a user input through a user interface device, the edutainment system includes: an electronic book processing part including an electronic book play unit sequentially playing unit book contents of the electronic book including a plurality of unit book contents, and a reading tracking unit analyzing a reading behavior of a user; and a game processing unit including a game executing unit executing the game including a plurality of game contents, and a game tracking unit analyzing a game play behavior of a user, wherein while the electronic book is being played by the electronic book play unit, the reading tracking unit tracks a user input through a user interface device to analyze the reading behavior of a user and then provides the analysis result for the game processing part, and the game executing unit executes the game in accordance with manipulation of a user, and when the analysis result on the reading behavior of a user is received from the reading tracking unit, the game executing unit selects game contents to be executed in the game, using the analysis result of the reading behavior and then executes the game contents that are selected.

Other features and aspects will be apparent from the following detailed description, the drawings, and the claims.

### Advantageous Effects

According to embodiments of the present invention, it is possible to provide an edutainment service in which learning is naturally performed through a play process by interworking an electronic book with a game.

Particularly, a user can acquire learning knowledge while reading interesting stories provided through an electronic book by dividing an edutainment service space into the electronic book and a game, and can strengthen the degree of understanding by repeating knowledge acquired through the game. Furthermore, a learning effect can be maximized by converting learned knowledge acquired through a repetitive game play into a long-term memory.

Meanwhile, since learning is naturally performed based on a play process just by keeping up with a play process, interest in a corresponding learning theme may not be lost without negative feeling to learning.

Also, as a user reads an electronic book or plays a game in accordance with embodiments, the learning progress situation or degree can be indirectly tracked through the behavior analysis on a user.

### DESCRIPTION OF DRAWINGS

FIG. 1 is a view illustrating an electronic book and a game executed in a terminal device;

FIG. 2 is a view illustrating the structure and relationship of an electronic book and a game together with a metadata system according to an embodiment of the present invention;

FIG. 3 is a view illustrating a connection relationship between a terminal device and servers through network; and

FIG. 4 is a view illustrating the configuration of an edutainment system according to an embodiment of the present invention.

### BEST MODE

Hereinafter, exemplary embodiments of the present invention will be described in detail with reference to the accompanying drawings. In order to clarify the present invention, a description irrelevant to the constitution of the present invention will be omitted, and in the drawings, like reference numerals refer to like elements throughout.

Since the terms “including”, “comprising”, and “having” can be construed as encompassing corresponding components unless specially described as opposite, it should be understood that they do not exclude other components but encompass other components. Unless defined otherwise, all technical and scientific terms have the same meanings as commonly understood by those skilled in the art to which the present invention belongs.

In the detailed description of the invention and claims, components named as “˜unit”, “˜part”, “˜module”, and “˜block” mean units that process at least one function or operation, and each of which can be implemented by software, hardware, or a combination thereof.

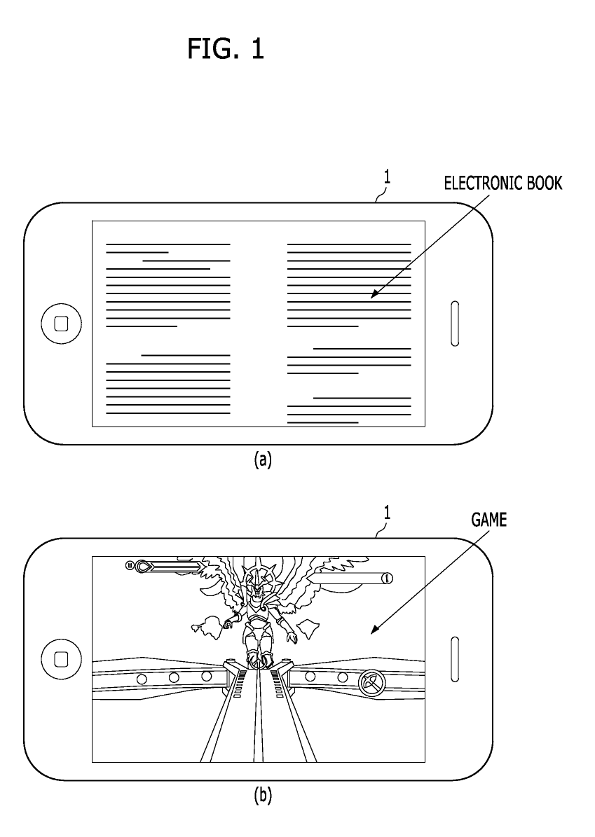

FIG. 1 is a view illustrating an electronic book and a game executed in a terminal device.

An edutainment system 100 according to an embodiment of the present invention does not force a user into explicit learning. Instead, the edutainment system 100 may allow a user to naturally acquire a concept while reading an interesting story included in an electronic book, and may enhance the degree of understanding by repetitively arousing the concept acquired through the game.

That is, the edutainment system 100 may induce a user to naturally learn while pleasantly playing a game using the electronic book and the game as shown in FIG. 1.

The electronic book as shown in FIG. 1 may include multimedia contents, which are configured in accordance with a certain order including text, image, and sound. A terminal device 1 may sequentially play the contents of electronic book.

A user may understand the story and content included in an electronic book by watching and hearing multimedia contents with eyes and ears. That is, this may correspond to a classic type of reading behavior.

The electronic book according to the embodiment of the present invention may include a multimedia type of stories which children of low age corresponding to elementary school students pleasantly read, and may include learning themes in the content thereof

However, an electronic type of textbooks and other electronic books that are explicitly manufactured for learning may not be excluded.

As shown in FIG. 1, the game may be executed in the terminal device 1, and may not be limited in genre and form thereof. That is, the game may be game software executed in platforms of computers, home consoles, and smartphones.

However, the game according to the embodiment may be a space that does not include only amusing elements but also includes learning elements.

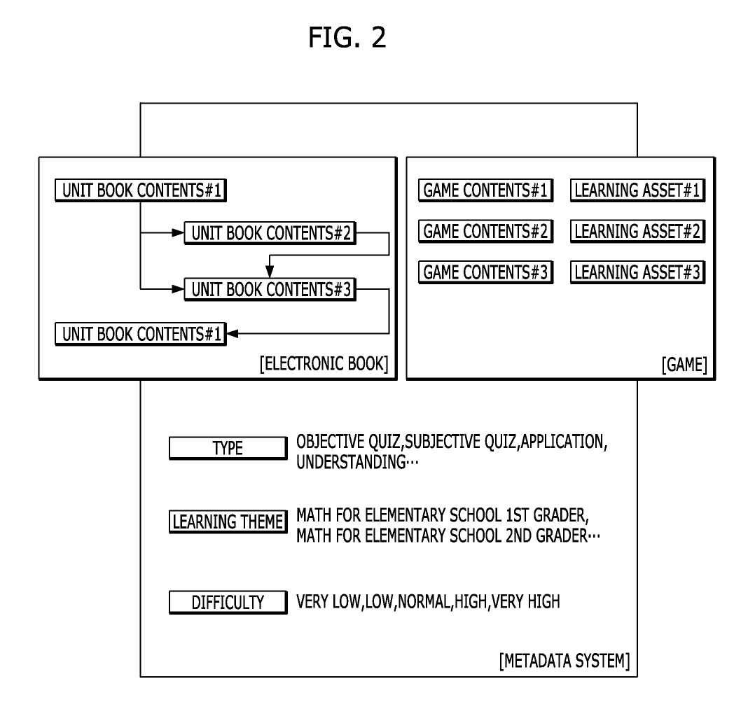

FIG. 2 is a view illustrating the structure and relationship of an electronic book and a game together with a metadata system according to an embodiment of the present invention.

First, an electronic book may include a plurality of unit book contents.

The unit book contents may be a basic unit of electronic book, and may be a unit corresponding to “page” and “chapter”.

That is, unit book contents may correspond to a portion of whole story.

Also, these unit book contents may have an order.

The terminal device 1 may play the unit book contents according to the order, and thus reading behavior on the electronic book may be performed.

Meanwhile, the important point may be that the electronic book supports multiple branching.

That is, at least a portion of unit book contents may be connected to next two or more unit book contents.

One of unit book contents may be played in accordance with the reading behavior of a user in a process in which the electronic book is played, or in accordance with other branching conditions, and then unit book contents to be played thereafter may be selected or changed.

That is, the flow of story may be changed in real-time.

In terms of narrative structure, so-called multi-ending may be supported.

Meanwhile, each unit book contents may include one or more “learning theme” metadata.

As described above, each unit book contents may include things related to learning. For example, an amusing anecdote describing why number π is 3.14 may be included in the content thereof

For example, the unit book contents including the content about number π may include “learning theme” metadata having a value called number π.

Metadata may be more elaborately configured so as to have a plurality of layers. In the above example, metadata may also include a value like “math for elementary school-sixth grader-first semester-chapter 3-number π”.

Learning theme metadata may correspond to metadata that serve to identify learning content included in the corresponding unit book contents.

In addition, various metadata that can describe the attribute of unit book contents such as “difficulty” may be further added.

Meanwhile, metadata as shown in FIG. 2 may be stored together with electronic book or unit book contents, or may be separately stored.

The game as shown in FIG. 2 may include a plurality of game contents.

The game contents may mean one of various content elements configuring the game.

For example, in case of adventure game, the game contents may indicate a specific space on game world map, and in case of RPG game, may also indicate a specific quest or mission.

That is, the game contents may denote a unit that can be differentiated in terms of content from the whole game contents.

In this case, each game contents may have conditions (clear conditions) by which the corresponding game contents can be successfully played.

Meanwhile, the game contents may have “type” metadata.

For example, if game contents can be cleared only when a user meets and answers a Non-Player Character (NPC), the game contents may be a “subjective quiz” type. On the other hand, if game contents can be cleared by selecting one of some choice alternatives, the game contents may be an “objective quiz” type.

In addition, in case of game contents in which a specific motion needs to be performed base on understanding about knowledge or a user needs to move along a specific motion line, the game contents may be “application” or “understanding” type.

Meanwhile, the game may have a learning asset separately from the game contents.

The learning asset may denote unit elements prepared so as to reflect learning elements in the game contents.

For example,

“Question of NPC: How long is the circumference of a circle with a radius of 1 cm?”

“Right answer: 6.24 cm”,

“Reply of NPC to right answer: Correct”,

“Typical wrong answer: 3.14 cm”,

“Reply of NPC to typical wrong answer: You are mixing up radius with diameter”,

“Reply of NPC to other wrong answers: Think again.”

As above, the learning asset may be data including values about some items which can be reflected in the game, e.g., question of NPC, answer, reply of NPC to right answer, typical wrong answer, reply of NPC to typical wrong answer, and reply of NPC to other wrong answers.

If necessary, the learning asset may further include multimedia contents in addition to text.

Meanwhile, the learning asset may not be reflected in all game contents.

For example, the learning asset can be reflected in game contents of “subjective quiz” type in which a user needs to meet NPC and input an answer, but is difficult to apply to the “application” or “objective quiz” type.

Accordingly, each learning asset may have applicable “type” metadata.

The learning asset can be applied to game contents having the same “type” metadata as its own “type” metadata.

Meanwhile, each learning asset may include “learning theme” metadata.

For example, “learning theme” metadata of the learning asset described above may have a value “number π”.

Also, “learning theme” metadata may include a value like “math for elementary school-sixth grader-first semester-chapter 3-number π”.

Meanwhile, the game may include a plurality of learning assets having the same “learning theme” metadata.

As described later, the electronic book and the game as shown in FIG. 2 may interwork with each other through metadata system finely configured. The terminal device 1 may analyze the reading behavior of a user about each unit book contents that a user has read, and may check the reading frequency and the degree of interest with respect to the unit book contents about any learning theme.

The interaction of a user about each unit book contents may be performed in various methods such as click, turn page, play, and pause. Weighted values or attributes may be assigned to each interaction behavior to extract indicators such as learning themes which a user is interested in and reads by occurrence time and frequency of interaction behaviors.

There may be a simple algorithm that quantitatively analyzes the degree of interest of a user in each unit book contents by multiplying weighted values of interaction behaviors by occurrence time and frequency of interactions. In addition, a more elaborate algorithm may be used for each attribute of interactions or each attribute of learning themes.

More specific algorithms may be freely selected, and may not belong to the scope of the present invention.

Meanwhile, when a user reads a book and then plays game after the reading behavior, the terminal device 1 may reflect the analysis results on reading behavior information collected during the reading behavior of a user in the game.

That is, the terminal device 1 may determine learning assets of learning themes to be provided during the game play, and may select game contents to which the corresponding learning assets are applicable before the game play.

In this case, a plurality of learning assets may be selected in regard to the same learning theme.

When the content of the electronic book includes a concept or basic knowledge related to a specific learning theme, the learning asset may correspond to an exercise that allows a user to repeatedly learn the concept or knowledge through game play examples.

A plurality of selected learning assets may be reflected when a user plays specific game contents. Whenever a user repeatedly plays the game contents, a different learning asset, i.e., next learning asset among the selected learning assets may be reflected.

For example, after reading the story about “number π” through the electronic book, a user may repeatedly play game contents in which a learning asset for understanding or applying the number π is reflected through the game.

Meanwhile, when there is a game play of a user, the terminal device 1 may analyze the game play behavior.

For example, the terminal device 1 may check the average clear time, the number of retries for clear, the change of clear time or accuracy, and the clear difficulty for game contents about a specific learning theme.

Thus, the skill change of a user for a specific learning theme can be inferred by analyzing the game play behavior of a user.

That is, the degrees of comprehension and skill of a user can be inferred through the behavior analysis on the game play of a user instead of direct assessment.

Meanwhile, when a user shows a sufficient skill, the terminal device 1 may reselect a learning asset having higher “difficulty” metadata, and may reflect the learning asset when a user plays the game contents.

On the other hand, when a user plays the game and then reads the book, the terminal device 1 may again play the electronic book from the last part that a user read, using the analysis result on the game play behavior tracked during the game play of a user. In this case, the terminal device 1 may determine a branching direction of the next unit book contents.

For example, when a user has a difficulty in applying “number π” through the game play, the play of the electronic book may be branched to unit book contents including a story lucidly explaining “number π”. When the analysis result on the game play behavior of a user shows that a user was not interested in “number π” at all, the play of the electronic book may also be branched to unit book contents about a different theme.

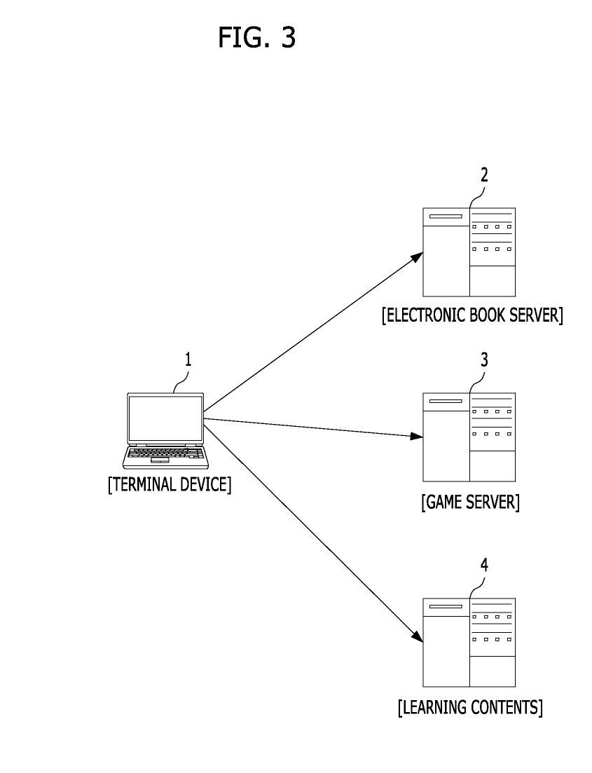

FIG. 3 is a view illustrating a connection structure between a terminal device and servers through network.

The terminal device 1 may correspond to hardware that receives a user input through a user interface device and plays an electronic book or a game to display the electronic book or the game through a display device.

The user interface device may include a keyboard, a mouse, and a touchscreen, and the display device may include an LCD monitor or a touchscreen.

In addition, an output device such as a speaker may be further provided, and a wired/wireless communication adapter for accessing the server through the network may be further provided.

For example, the terminal device 1 may include a personal desktop computer, a laptop, a smartphone, and a tablet.

Meanwhile, the electronic book server 2 may provide electronic book data by a downloading or streaming method for the terminal device 1 connected through the network, or may collect tracking information on the reading behavior with respect to the electronic book.

The game server 3 may provide game data by a downloading or streaming method for the terminal device 1 connected through the network, or may provide various kinds of data services for the execution of the game. Furthermore, the game server 3 may also collect and track the game play behaviors.

The learning contents server 4 may include learning contents about each learning theme. The learning contents may be a short video clip related to a specific learning theme.

For example, the learning contents may be audiovisual materials explaining the learning theme, or may be a lecture video of a lecturer about the learning theme.

The learning contents server 4 may provide learning contents about a specific learning theme in real-time when there is a request of the terminal device 1. The learning contents server 4 may provide data of video clip by a streaming method.

Meanwhile, the electronic book server 2, the game server 3, and the learning contents server 4 have been described as separate components, but may be mounted in or implemented in single server hardware or may be implemented in a plurality of server farms or groups.

The edutainment system 100 may be implemented in the terminal device 1 connected to the electronic book server 2, the game server 3, and the learning contents server 4 through the network.

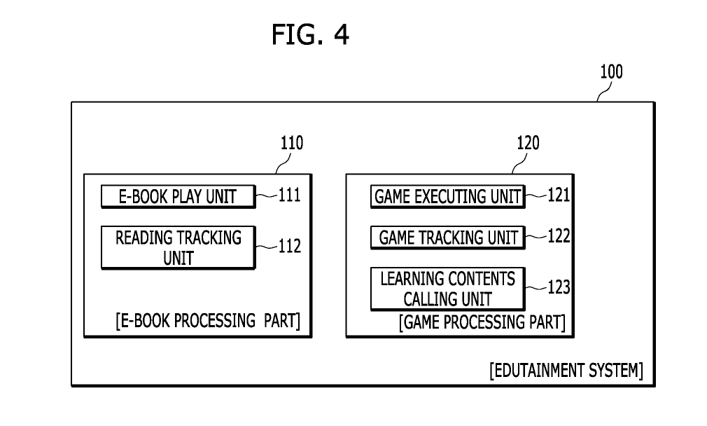

FIG. 4 is a view illustrating the configuration of an edutainment system according to an embodiment of the present invention.

As shown in FIG. 4, the edutainment system 100 may include an electronic book processing part 110 and a game processing part 120.

The electronic book processing part 110 may play and display the electronic book having the structure described above, and may analyze a user interface input of a user during the reading to track the reading behavior.

Also, the electronic book processing unit 110 may provide the tracking result for the game processing part 120.

Meanwhile, the game processing part 120 may execute the game, and may analyze and track the game play behavior of a user to provide the analysis and tracking results for the electronic book processing part 110.

The electronic book processing part 110 may include a electronic book play unit 111 and a reading tracking unit 112.

The electronic book play unit 111 may sequentially play unit book contents of the electronic book including a plurality of unit book contents. As described above, the unit book contents of the electronic book may be played in a determined order, and the electronic book play unit 111 may play the unit book contents in the determined order.

In this case, at least a portion of the unit book contents included in the electronic book, as illustrated in FIG. 2, may branch into two or more unit book contents.

Also, any one of unit book contents may be played in accordance with the reading behavior of a user, or in accordance with other branching conditions, and then unit book contents to be played thereafter may be selected or changed.

The reading tracking unit 112 may analyze the reading behavior of a user.

While the electronic book is being played by the electronic book play unit 111, the reading tracking unit 112 may track the input of a user through a user interface device to analyze the reading behavior of a user, and then may provide the analysis result for the game processing part 120.

Meanwhile, the game processing part 120 may include a game executing unit 121, a game tracking unit 122, and a learning contents calling unit 123.

The game executing unit 121 may execute a game including a plurality of game contents.

The game tracking unit 122 may analyze the game play behavior of a user.

As described later, the learning contents calling unit 123 may request learning contents from the learning contents server 4 during the game play, and may receive the learning contents by a streaming method to display the learning contents on the game play screen.

In this case, the game executing unit 121 may execute the game in accordance with manipulation of a user. When the analysis result on the reading behavior of a user is received from the reading tracking unit 112, the game executing unit 121 may select game contents to be executed in the game, using the analysis result of the reading behavior, and then may execute the game contents that are selected.

After the game tracking unit 122 analyzes the game play behavior of a user, the game tracking unit 122 may provide the analysis result for the electronic book processing part 110.

When the electronic book processing part 111 receives the analysis result of the game play behavior of a user from the game tracking unit 122, the electronic book processing part 111 may select unit book contents to be branched using the received analysis result of the game play behavior after the play of the unit book contents which are branched into two or more unit book contents, and may further play the selected unit book contents.

That is, as shown in FIG. 2, where there are two or more next unit book contents after any one of unit book contents is played, the electronic book processing part 111 may determine one of the two or more next unit book contents using the analysis result of the game play behavior which are received.

In other words, the analysis result of the game play behavior may become a criterion of the branching conditions.

When the analysis result of the game play behavior is not received, default one of the two or more unit book contents may be played.

Hereinafter, a process of determining the branching direction among two or more unit book contents by the electronic book processing part 111 will be described in detail.

The electronic book may further include branching condition variables and information on two or more unit book contents into which one or more unit book contents are to be branched after the play of the corresponding unit book contents.

That is, the electronic book may include a pointer for two or more next unit book contents, or the unit book contents may be connected to each other in a form of linked list.

Also, the electronic book may have the branching condition variables to determine the branching direction.

The branching condition variable may have a value that is a natural number between 1 and 10. When the value is between 1 and 5, branching may be performed to the first unit book contents. On the other hand, when the value is between 6 and 10, branching may be performed to the second unit book contents.

The electronic book play unit 111 may use the analysis result of the game play behavior of a user received from the game tracking unit 122 as the branching condition variable.

In the above example, when the game tracking unit 122 returns a value “4” as the analysis result of the game play behavior of a user, the electronic book play unit 111 may perform branching to the first unit book contents among the next two unit book contents.

Hereinafter, a process of tracking the reading behavior by the reading tracking unit 112 will be described in detail.

The electronic book may include identification information of one or more learning themes corresponding to one of one or more unit book contents included in the electronic book.

As shown in FIG. 2, the electronic book may have an item “learning theme” as metadata for each unit book contents.

The item “learning theme” may have a text type of value like “math for elementary school first grader”, but may include a digit or character string to be uniquely identified.

Meanwhile, the reading tracking unit 112 may check whether there is an interaction of a user with respect to a specific learning theme and, if any, may analyze the frequency of interaction of a user, the duration time of interaction of a user, and the type of interaction of a user, by tracking the input of a user through the user interface device while the unit book contents are being played by the electronic book play unit 111.

That is, tracking may be performed for each unit book contents, but may be performed by “learning theme.”

In other words, tracking may be performed on the unit book contents having the same “learning theme”.

Continuous or discrete some unit book contents may have the same learning theme. While the unit book contents having the same learning theme are being played, the interaction of a user may be tracked.

Meanwhile, when a user intends to stop reading and start playing game, the game executing unit 121 may select one or more game contents related to a specific learning theme in which the interaction of a user exists, using the analysis result of the reading behavior of a user received from the reading tracking unit 112.

As described above, the game contents may include metadata “learning theme”. When a user performs a specific interaction for a certain time or more with a certain frequency or more, it can be determined whether a user shows an interest in the corresponding “learning theme”, whether a user is interested in the corresponding “learning theme”, whether a user does not understand the corresponding “learning theme”, or whether a user is bored of the “learning theme”. Accordingly, appropriate game contents can be selected.

The interaction of a user may include various types such as turning pages and repeated play in addition to simple operation like simple clicking or dragging. Also, weighted values or attributed may be assigned to each type of interaction to form an algorithm for selecting game contents from the tracking result of the reading behavior of a user.

A process of selecting game contents to be provided for a user during the game play by the game executing unit 121 may be more specifically limited as follows.

First, the game executing unit 121 may select one or more game assets corresponding to a specific learning theme in which the interaction of a user exists, using the analysis result of the reading behavior of a user received from the reading tracking unit 112.

Then, the game contents according to the type of the selected learning asset may be selected.

That is, the learning assets and the game contents may have “type” metadata item, respectively, and the attribute values thereof need to coincide.

Thus, when the learning assets and the game contents, “type” metadata of which coincide, are selected, the game executing unit 121 may execute the selected game contents. In this case, the game executing unit 121 may apply the learning assets to the game contents.

For example, in the algorithm for selecting the learning assets and the game contents, weighted values may be assigned for each type of interaction of a user. In this case, game contents according to the type of learning theme in which a value obtained by multiplying the frequency of interaction of a user by the weighted value or multiplying the duration time of interaction of a user by the weighted value is determined as the largest may be selected, or the learning assets corresponding to the learning theme may be selected.

Meanwhile, the game tracking unit 122 may determine the skill change of a user with respect to a specific learning theme from the number of clears and the time spent for clear of the game contents to which the learning asset about a specific learning theme provided in the game is applied.

The learning asset provided through the game contents may correspond to a process of learning by repeating or practicing the knowledge or concept acquired during the reading process of the electronic book by a user, and it may be significant to track the degree of skillfulness about the same learning theme.

Meanwhile, when the clear time of the game contents applied to the learning asset corresponding to a specific learning theme is equal to or larger than an upper threshold value, i.e., when a user spends much time to clear the game contents, the game executing unit 121 may select a learning asset having lower difficulty as a learning asset corresponding to the same learning theme as the already selected learning asset.

Also, when the corresponding game contents are executed, a newly selected learning asset may be applied.

On the other hand, when the clear time of the game contents applied to the learning asset corresponding to a specific learning theme is equal to or less than a lower threshold value, i.e., when a user clicks the game contents in a very short time to clear the game, the game executing unit 121 may select a learning asset having higher difficulty as a learning asset corresponding to the same learning theme as the already selected learning asset. Thus, when the corresponding game contents are again executed, the newly selected learning asset may be applied.

When a case where the clear time of game contents to which the learning assets corresponding to the same learning theme are applied is equal to or larger than the upper threshold value is repeated with a certain number of times, i.e., when a user still has a difficulty in solving a problem although repeatedly encountering the learning assets about the same learning theme, the learning contents calling unit 123 may request the learning contents about the learning theme of the corresponding learning asset from the learning contents server 4 through the network during the game play.

Alternatively, even when the clear failure of the game contents to which the learning assets corresponding to the same learning theme are applied is repeated a certain number of times, the learning contents calling unit 123 may request the game contents about the learning theme of the corresponding learning assets.

In this case, the learning contents may be a video clip that is a video lecture recorded about the corresponding learning theme.

When the learning contents calling unit 123 receives learning contents from the learning contents server 4, the learning contents calling unit 123 may overlay the learning contents on the display device during the game play.

When the learning contents are video clip, the learning contents may be received by a streaming method, and may be overlaid on the game screen in real-time.

Basically, the game play may be performed such that a user cannot recognize the game as learning. However, when a user never solve a problem in spite of repeated play, a user may be regarded as inapprehensive about the concept, and may be allowed to learn while directly viewing the lecture clip.

This is executed to prevent a user from losing interest by experiencing difficulties even in playing game not learning.

Meanwhile, while the game play is being performed, the game tracking unit 122 may track the skill change of a user with respect to the specific learning theme, the difficulty adjustment of the learning asset corresponding to the specific learning theme, the skill change after the difficulty adjustment of the learning asset corresponding to the specific learning theme, and the reception of the learning contents related to the specific learning theme by the learning contents calling unit 123.

That is, tracking may be performed based on the game contents or the learning assets having the same “learning theme” metadata.

Also, the tracking result, i.e., “the analysis result of the game play behavior of a user” may be provided for the electronic book processing part 110.

Meanwhile, a series of processes executed in the electronic book processing part and the game processing part of the edutainment system according to the embodiments of the present invention can also be embodied as computer readable codes on a computer readable recording medium.

In this case, the computer readable recording medium is any data storage device that can store data which can be thereafter read by a computer system. Examples of the computer readable recording medium include DVD-read only memories (DVD-ROMs), CD-ROMs, hard disks, USB memories, and flash memories.

Meanwhile, the expression, ‘stored in a recording media’ does not compass only a case where contents are stored in recording media in mass quantity and distributed in a form of package, but also a case where contents are stored in recording media through a network in a form of data packet.

Although the term ‘network’ is used in this disclosure, the term should be construed as a broad concept compassing well-known wired/wireless communication methods such as Local Area Network (LAN) and Wide Area Network (WAN) depending on the distance and size, intranet and Virtual Private Network (VPN) depending on the characteristics of the connection route, and Wibro and WiFi depending on the connection method.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### MODE FOR INVENTION

### Industrial Applicability

The present invention can be applied to the edutainment technology field.

1. An edutainment system for supporting interworking between an electronic book and a game, the system comprising a terminal device playing the electronic book or the game to display on a display device in accordance with a user input through a user interface device, the edutainment system comprising:
an electronic book processing part comprising an electronic book play unit sequentially playing unit book contents of the electronic book comprising a plurality of unit book contents, and a reading tracking unit analyzing a reading behavior of a user; and
a game processing unit comprising a game executing unit executing the game comprising a plurality of game contents, and a game tracking unit analyzing a game play behavior of a user,
wherein:
at least one of the unit book contents comprised in the electronic book branches into two or more unit book contents;
while the electronic book is being played by the electronic book play unit, the reading tracking unit tracks a user input through a user interface device to analyze the reading behavior of a user, and then provides the analysis result for the game processing part;
the game executing unit executes the game in accordance with manipulation of a user, and when the analysis result on the reading behavior of a user is received from the reading tracking unit, the game executing unit selects game contents to be executed in the game, using the analysis result of the reading behavior and then executes the game contents that are selected;
the game tracking unit analyzes the game play behavior of a user, and then provides the analysis result for the electronic book processing part; and
the electronic book play unit plays the unit book contents comprised in the electronic book in a certain order when the electronic book is played, and
when the analysis result of the game play behavior of a user is received from the game tracking unit, selects unit book contents to be branched using the received analysis result of the game play behavior after the play of the unit book contents which branch into two or more unit book contents and further plays the selected unit book contents.

2. The edutainment system of claim 1, wherein the electronic book further comprises branching condition variables and information on two or more unit book contents into which one or more unit book contents are to be branched after the play of the corresponding unit book contents, and
the electronic book play unit selects unit book contents to be branched from unit book contents that are being played, by using the analysis result of the game play behavior of a user received from the game tracking unit as the branching condition variable.

3. The edutainment system of claim 1, wherein the electronic book comprises identification information of one or more learning themes corresponding to any one of one or more unit book contents comprised in the electronic book, and
the reading tracking unit checks whether there is an interaction of a user with respect to a specific learning theme by tracking the user input through the user interface device while the unit book contents are being played by the electronic book play unit, and analyzes the reading behavior by analyzing one or more of the frequency of interaction of a user, the duration time of interaction of a user, and the type of interaction of a user.

4. The edutainment system of claim 1, wherein the game executing unit selects one or more game contents related to a specific learning theme in which there is an interaction of a user, using the analysis result of the reading behavior of a user received from the reading tracking unit.

5. The edutainment system of claim 4, wherein the game executing unit:
selects one or more game assets corresponding to the specific learning theme in which the interaction of a user exists, using the analysis result of the reading behavior of a user received from the reading tracking unit;
selects game contents according to the type of the selected learning asset; and
executes the selected game contents by applying the learning asset to the game contents, and
the learning asset is for repeated learning of the learning theme and comprises a plurality of elements applicable to the game contents.

6. The edutainment system of claim 5, wherein when the game executing unit selects the game contents or the learning asset, weighted values are assigned for each type of interaction of a user, and selects game contents according to the type of a learning theme in which a value obtained by multiplying the frequency of interaction of a user by the weighted value or multiplying the duration time of interaction of a user by the weighted value is determined as the largest, or learning assets corresponding to the learning theme.

7. The edutainment system of claim 5, wherein the game tracking unit determines a skill change of a user with respect to a specific learning theme from the number of clears or the time spent for clear of game contents to which a learning asset about a specific learning theme provided in the game is applied.

8. The edutainment system of claim 5, wherein when the clear time of the game contents to which the learning asset corresponding to a specific learning theme is applied is equal to or larger than an upper threshold value, the game executing unit selects a learning asset having lower difficulty as a learning asset corresponding to the same learning theme as the already selected learning asset, and
when the clear time of the game contents to which the learning asset corresponding to a specific learning theme is applied is equal to or less than a lower threshold value, the game executing unit selects a learning asset having higher difficulty as a learning asset corresponding to the same learning theme as the already selected learning asset,
applying the learning asset when the game contents are again executed.

9. The edutainment system of claim 5, wherein the game processing part further comprises a learning contents calling unit that receives learning contents about the learning theme from a learning contents server through a network and overlays the learning contents on the display device during the game play when a case where the clear time of game contents to which the learning assets corresponding to the same learning theme are applied is equal to or larger than an upper threshold value is repeated with a certain number of times, or when the clear failure of the game contents to which the learning assets corresponding to the same learning theme are applied is repeated a certain number of times.

10. The edutainment system of claim 7, wherein the game tracking unit provides, for the electronic book processing part, an analysis result of the game play behavior of a user which comprises one or more pieces of information of the skill change of a user with respect to the specific learning theme, the difficulty adjustment of the learning asset corresponding to the specific learning theme, the skill change after the difficulty adjustment of the learning asset corresponding to the specific learning theme, and the reception of the learning contents related to the specific learning theme by a learning contents calling unit.

11. An edutainment system for supporting interworking between an electronic book and a game, the system comprising a terminal device playing the electronic book or the game to display on a display device in accordance with a user input through a user interface device, the edutainment system comprising:
an electronic book processing part comprising an electronic book play unit sequentially playing unit book contents of the electronic book comprising a plurality of unit book contents, and a reading tracking unit analyzing a reading behavior of a user; and
a game processing unit comprising a game executing unit executing the game comprising a plurality of game contents, and a game tracking unit analyzing a game play behavior of a user,
wherein:
at least one of the unit book contents comprised in the electronic book branches into two or more unit book contents;
the game tracking unit analyzes the game play behavior of a user, and then provides the analysis result for the electronic book play unit; and
the electronic book play unit plays the unit book contents comprised in the electronic book in a certain order when the electronic book is played, and
when the analysis result of the game play behavior of a user is received from the game tracking unit, selects unit book contents to be branched using the received analysis result of the game play behavior after the play of the unit book contents which branch into two or more unit book contents and further plays the selected unit book contents.

12. An edutainment system for supporting interworking between an electronic book and a game, the system comprising a terminal device playing the electronic book or the game to display on a display device in accordance with a user input through a user interface device, the edutainment system comprising:
an electronic book processing part comprising an electronic book play unit sequentially playing unit book contents of the electronic book comprising a plurality of unit book contents, and a reading tracking unit analyzing a reading behavior of a user; and
a game processing unit comprising a game executing unit executing the game comprising a plurality of game contents, and a game tracking unit analyzing a game play behavior of a user,
wherein while the electronic book is being played by the electronic book play unit, the reading tracking unit tracks a user input through a user interface device to analyze the reading behavior of a user and then provides the analysis result for the game processing part, and
the game executing unit executes the game in accordance with manipulation of a user, and when the analysis result on the reading behavior of a user is received from the reading tracking unit, the game executing unit selects game contents to be executed in the game, using the analysis result of the reading behavior and then executes the game contents that are selected.

13. The edutainment system of claim 8, wherein the game tracking unit provides, for the electronic book processing part, an analysis result of the game play behavior of a user which comprises one or more pieces of information of the skill change of a user with respect to the specific learning theme, the difficulty adjustment of the learning asset corresponding to the specific learning theme, the skill change after the difficulty adjustment of the learning asset corresponding to the specific learning theme, and the reception of the learning contents related to the specific learning theme by a learning contents calling unit.

14. The edutainment system of claim 9, wherein the game tracking unit provides, for the electronic book processing part, an analysis result of the game play behavior of a user which comprises one or more pieces of information of the skill change of a user with respect to the specific learning theme, the difficulty adjustment of the learning asset corresponding to the specific learning theme, the skill change after the difficulty adjustment of the learning asset corresponding to the specific learning theme, and the reception of the learning contents related to the specific learning theme by a learning contents calling unit.
